(19) United States
(12) Patent Application Publication
(10) Pub. No.: US 2013/0278859 A1
(43) Pub. Date: Oct. 24, 2013

(54) LIQUID CRYSTAL DISPLAY HAVING FRAME DEFINING ACCESS THEREIN

(71) Applicant: SYNERGY OPTOELECTRONICS (SHENZHEN) CO., LTD., Shenzhen (CN)

(72) Inventors: CHUN-YUN PAN, Hsinchu (TW); CHIH-YUNG WANG, Hsinchu (TW)

(73) Assignee: SYNERGY OPTOELECTRONICS (SHENZHEN) CO., LTD., Shenzhen (CN)

(21) Appl. No.: 13/851,979

(22) Filed: Mar. 28, 2013

(30) Foreign Application Priority Data
Mar. 30, 2012 (CN) 2012100897408

(51) Int. Cl. G02F 1/1335

(52) U.S. Cl. CPC G02F 1/133608
USPC 349/58

(57) ABSTRACT

A liquid crystal display includes a first frame, a second frame, a liquid crystal panel, and a backlight module. The backlight module includes a light guide plate, a light source assembly, and a third frame. The light guide plate includes a light incident surface. The third frame defines an access corresponding to the light incident surface. The first and second frames cooperate to receive the liquid crystal panel and the backlight module. The light source assembly is attached to the first frame and located outside of the third frame. The light guide plate is received in the third frame, and the light source assembly faces the light incident surface of the light guide plate via the access.

### BACKGROUND

1. Technical Field

The present disclosure relates to display technologies, and particularly, to a liquid crystal display having frame defining access therein.

2. Description of Related Art

A typical liquid crystal display employs a number of light emitting diodes (LEDs) as a light source of a backlight module. The size of the backlight module can be reduced by decreasing a distance between each LED and a light incident surface of the light guide plate. However, the maximum divergent angle of light emitted by the LED is limited. If the light incident surface is close to the LEDs, some areas of the light incident surface between two adjacent LEDs may fail to receive the light and be relatively dark. That is, the light emitted from the backlight module may be non-uniform, and the performance of an associated LCD may be visibly impaired.

What is needed, therefore, is a new liquid crystal display which can overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded view of a liquid crystal display device, according to a first embodiment of the present disclosure, the liquid crystal display including a first frame, a second frame, a third frame, a light guide plate, and a reflector.

FIG. 2 is an isometric view of the third frame of FIG. 1.

FIG. 3 is an isometric view of the light guide plate of FIG. 1.

FIG. 4 is an assembled view of the liquid crystal display of FIG. 1.

FIG. 5 is a partial cross-sectional view taken along line V-V of FIG. 4.

FIG. 6 is an exploded view of a liquid crystal display device, according to a second embodiment of the present disclosure, the liquid crystal display including a first frame, a second frame, a third frame, a light guide plate, and a reflector.

FIG. 7 is an isometric view of a circled portion VII of the third frame of FIG. 6.

FIG. 8 is an isometric view of a circled portion VIII of the second frame of FIG. 6.

FIG. 9 is an assembled view of the liquid crystal display of FIG. 6.

FIG. 10 is a partial cross-sectional view taken along line X-X of FIG. 9.

FIG. 11 is an exploded view of a liquid crystal display device, according to a third embodiment of the present disclosure.

FIG. 12 is an assembled view of the liquid crystal display of FIG. 11.

FIG. 13 is a partial cross-sectional view taken along line XIII-XIII of FIG. 12.

### DETAILED DESCRIPTION

Reference will be made to the drawings to describe various embodiments.

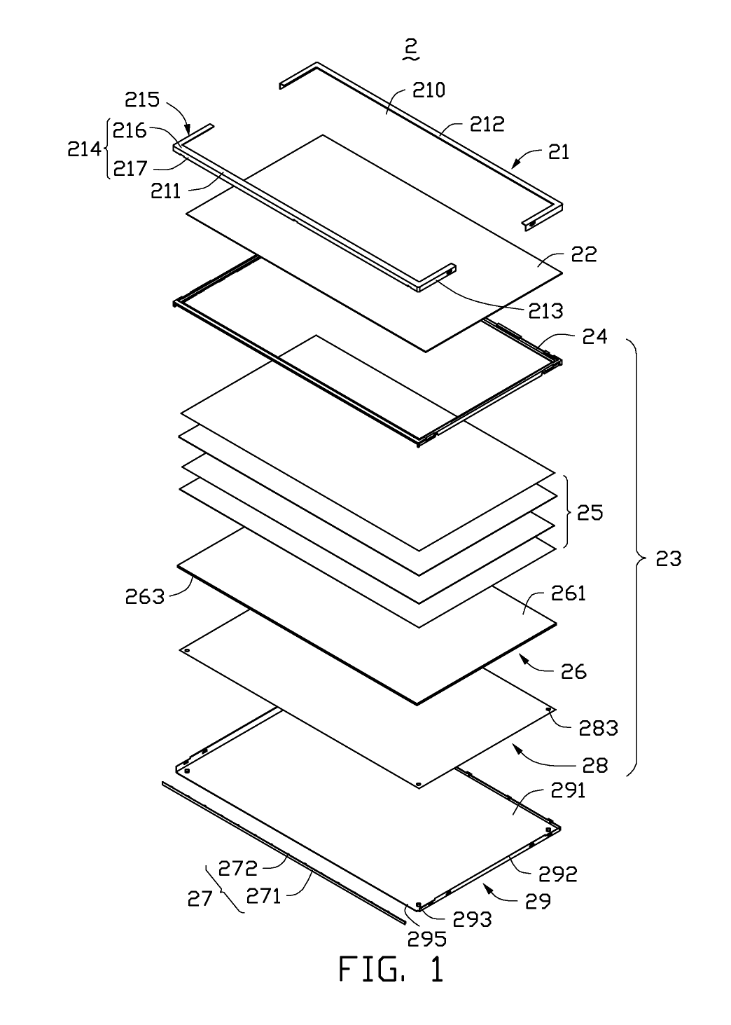

Referring to FIG. 1, in a first embodiment, a liquid crystal display 2 includes a first frame 21, a second frame 29, a liquid crystal panel 22, and a backlight module 23. The first frame 21 engages with the second frame 29 to define a first accommodating space to receive the liquid crystal panel 22 and the backlight module 23. The major portion of the surface of the liquid crystal panel 22 essentially serves as a display screen (not labeled). The first frame 21 defines a display window 210 corresponding to the display screen of the liquid crystal panel 22.

The first frame 21 includes a first part 211 and a second part 212. Each of the first and second parts 211, 212 has a generally U-shaped configuration, and includes a first portion 213, a second portion 214, and a third portion 215. The first and third portions 213, 215 perpendicularly extend from two opposite ends of the second portion 214. A length of the first portion 213 is the same as a length of the third portion 215.

Each of the first, second, and third portions 213, 214, 215 includes a horizontal wall 216 and a vertical wall 217 perpendicular to the horizontal wall 216. The horizontal walls 216 of the first, second and third portions 213, 214, 215 are coplanar. A number of first buckling members (not labeled) are attached on outer surfaces of the vertical walls 217 of the first, second and third portions 213, 214, 215.

The second frame 29 includes a rectangular bottom plate 291, a number of first sidewalls 292, and a number of fixing poles 293. In this embodiment, the second frame 29 includes three first sidewalls 292 and four fixing poles 293. The first sidewalls 292 perpendicularly extend from two parallel short edges and one long edge of the bottom plate 291, thereby forming an opening 295 at the other long edge of the second frame 29. The fixing poles 293 extend from the bottom plate 291 along a direction parallel to the first sidewalls 292 and are located close to the four corners of the bottom plate 291. A number of second buckling members (not labeled) are attached on an outer surface of the first sidewalls 292, and each of the second buckling members corresponds to a respective one of the first buckling members.

The backlight module 23 includes a light guide plate 26, a light source assembly 27, a reflector 283, a number of optical films 25, and a third frame 24. The third frame 24 is configured to receive the light guide plate 26, the light source assembly 27, the reflector 283, and the optical films 25.

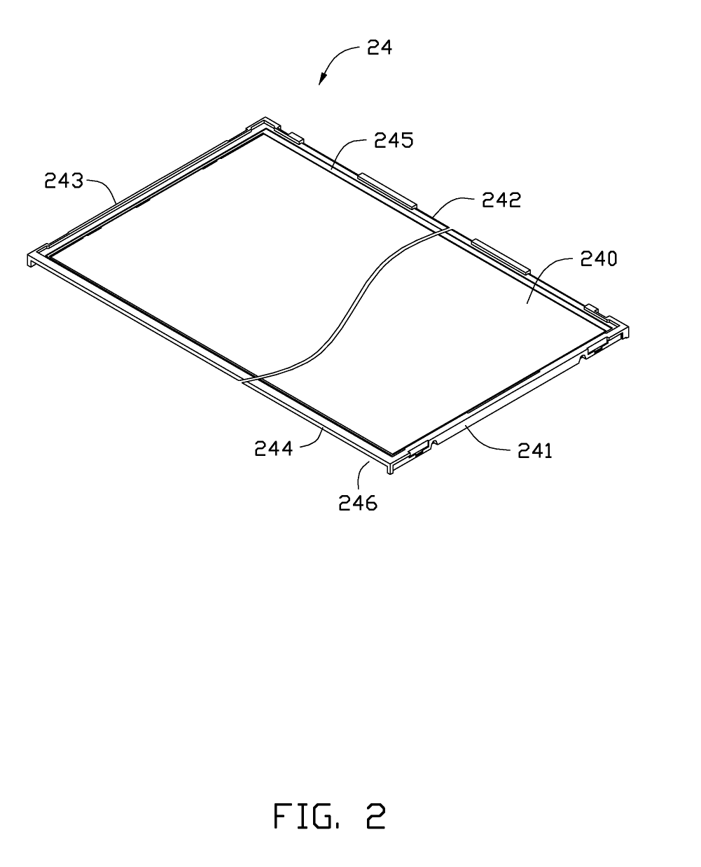

Referring also to FIG. 2, the third frame 24 includes four second sidewalls 241, 242, 243, 244 connected end to end, and a horizontal supporting wall 245 inwardly extending from the four second sidewalls 241, 242, 243, 244. The horizontal supporting wall 245 defines a window 240 therein. The window corresponds to the display window of the first frame 21. These second sidewalls 241, 242, 243 are of equal thickness, a thickness of the other second sidewall 244 is less than the thickness of the second sidewalls 241, 242, 243. Top surfaces of the second sidewalls 241, 242, 243, 244 are coplanar, such that there is a distance between a bottom surface of the other second sidewall 244 and a surface which defined by bottom surfaces of the three second sidewalls 241, 242, 243, thereby forming an access 246 between the bottom surface of the other second sidewall 244 and the surface which defined by the bottom surfaces of the three second walls 241, 242, 243. A number of third buckling members are attached on an outer surface of the second sidewalls 241, 242, 243, 244, and each third buckling member corresponds to a first and a second buckling member.

The light source assembly 27 includes a circuit board 271 and a number of LEDs 272 attached on the circuit board 271.

The reflector 28 defines a through hole 283 at each corner of the reflector 28. The four through holes 283 are formed corresponding to the fixing poles 293 of the second frame 29.

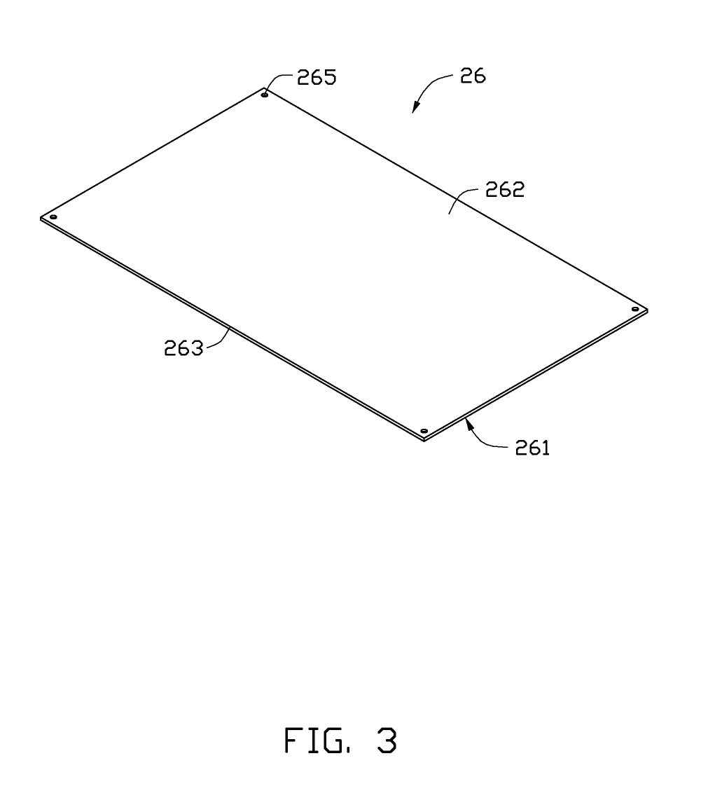

Referring also to FIG. 3, the light guide plate 26 includes a lateral light incident surface 263 corresponding to the light source assembly 27, a top light emitting surface 261 perpendicular to the light incident surface 263, and a bottom surface 262 opposite to the top light emitting surface 261. The bottom surface 262 defines four fixing holes 265 therein. A depth of each fixing hole 265 is less than a thickness of the light guide plate 26. The fixing holes 265 correspond to the fixing poles 293 of the second frame 29. The light guide plate 26 can, for example, be made from polycarbonate or polymethyl methacrylate (PMMA), and can be manufactured by an injection molding method.

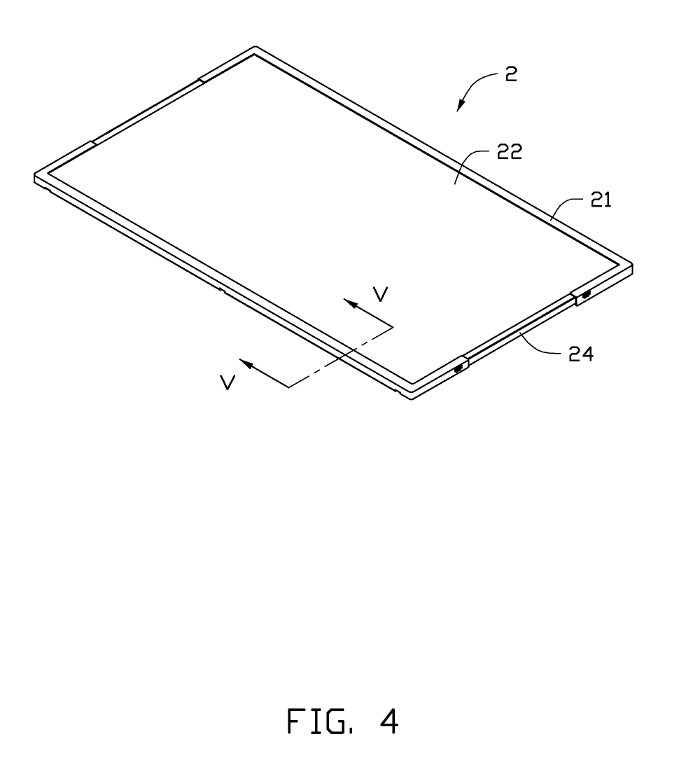

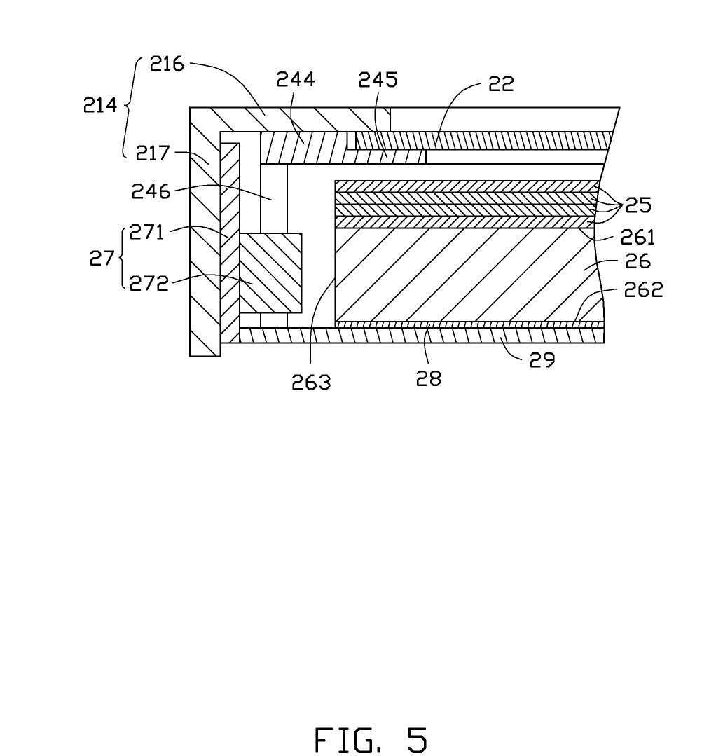

Referring also to FIGS. 4-5, in assembly of the liquid crystal display 2, the third frame 24, the optical films 25, the light guide plate 26, the reflector 28, and the second frame 29 are arranged from top to bottom. The second frame 29 engages with the third frame 24 to define a second accommodating space. The optical films 25, the light guide plate 26, and the reflector 28, are received in the second accommodating space. The second buckling members engage with the third buckling members. The first sidewalls 292 of the second frame 29 are located outside the second sidewalls 241, 242, 243 of the third frame 24. The opening 295 of the second frame 29 corresponds to the access 246 of the third frame 24. The optical films 25, the light guide plate 26, and the reflector 28 are located between the horizontal supporting wall 245 and the bottom plate 291. The fixing poles 293 pass through the through holes 283 and are inserted into the fixing holes 265. The light incident surface 263 corresponds to the access 246. The liquid crystal panel 22 is arranged on the horizontal supporting wall 245.

The circuit board 271 of the light source assembly 27 is attached to the vertical wall 217 of the second portion 214 of the first part 211.

The first part 211 and the second part 212 cooperatively engage with the second frame 29 via the first and second buckling members to receive the liquid crystal panel 22 and the backlight module 23. The second portions 214 correspond to two opposite sidewalls of the second sidewalls 242, 244. The vertical wall 217 to which the circuit board 271 is attached corresponds to the opening 295. The LEDs 272 are received in the opening 295 and correspond to the access 246 and face the light incident surface 263. The light guide plate 26 and the light source assembly 27 cooperatively provide uniform illumination for the liquid crystal panel 22.

The first portions 213 correspond to the opposite sides of the first sidewall 292 which is adjacent to the opening 295. The third portions 215 correspond to the opposite sides of another first sidewall 292 which is adjacent to the opening 295. A sum of lengths of the first portions 213 of the first and second parts 211, 212 is less than a length of the corresponding first sidewall 292 of the second frame 29, and because the lengths of the third portions 215 are the same as the lengths of the first portions 213, a sum of lengths of the third portions 215 is also less than a length of the corresponding first sidewall of the second frame 29, thereby the cost of the first frame 21 is reduced. The horizontal walls 216 of the first and second parts 211, 212 are located on the top surface of the third frame 24 and define the display window.

With the above-described configuration, the light source assembly is attached to the first frame 21, outside of the third frame 24, and whereby the distance between each LED 272 and the light incident surface 263 is increased. Light beams emitted from the LEDs 272 can reach more area of the light incident surface 263 of the light guide plate 26. That is, dark areas such as the dark area of the above-described conventional light guide plate are decreased. As a result, an improved uniformity of brightness of the backlight module can be achieved, and the performance of an associated LCD may be visibly improved.

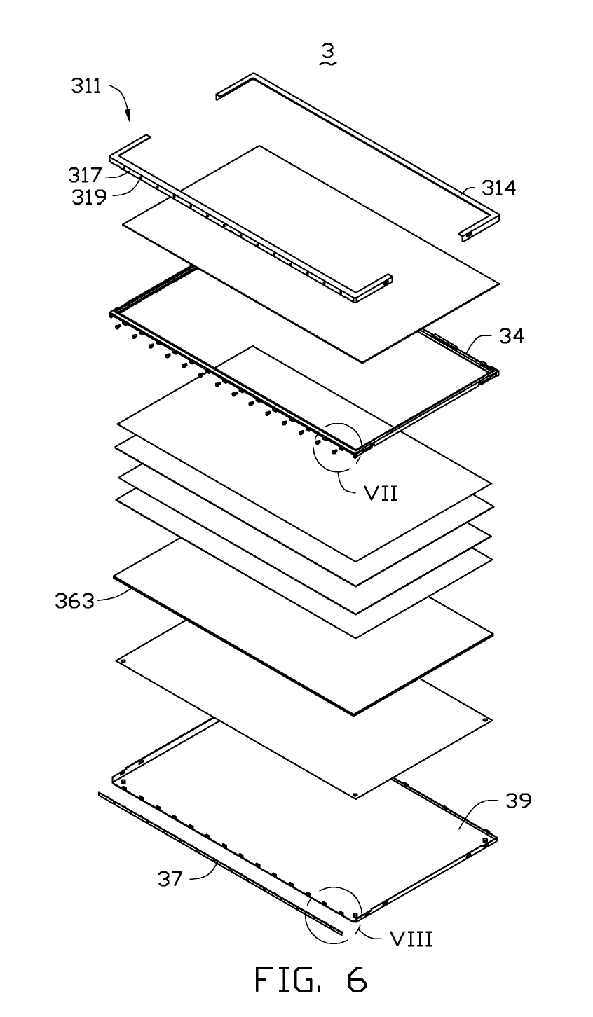

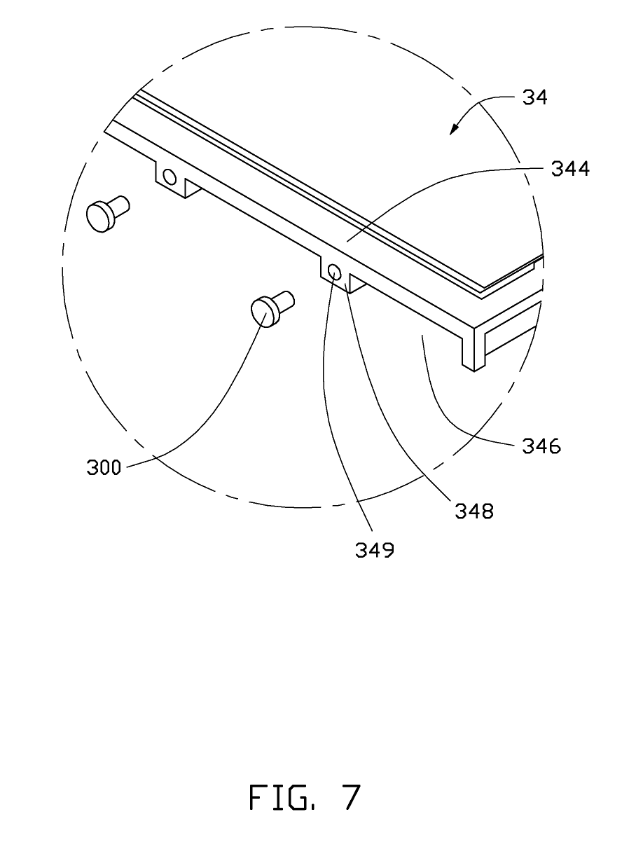

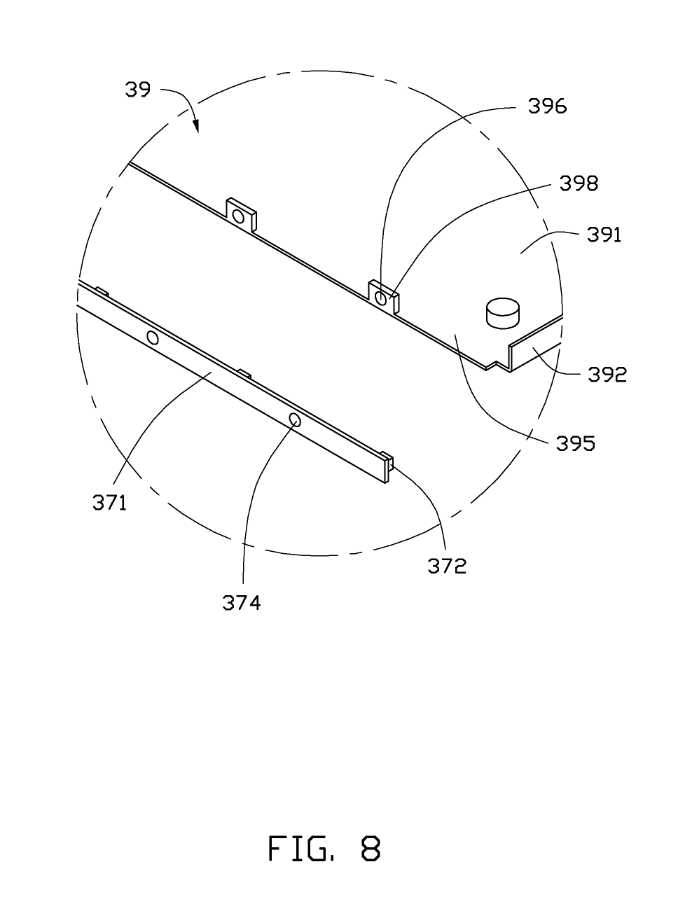

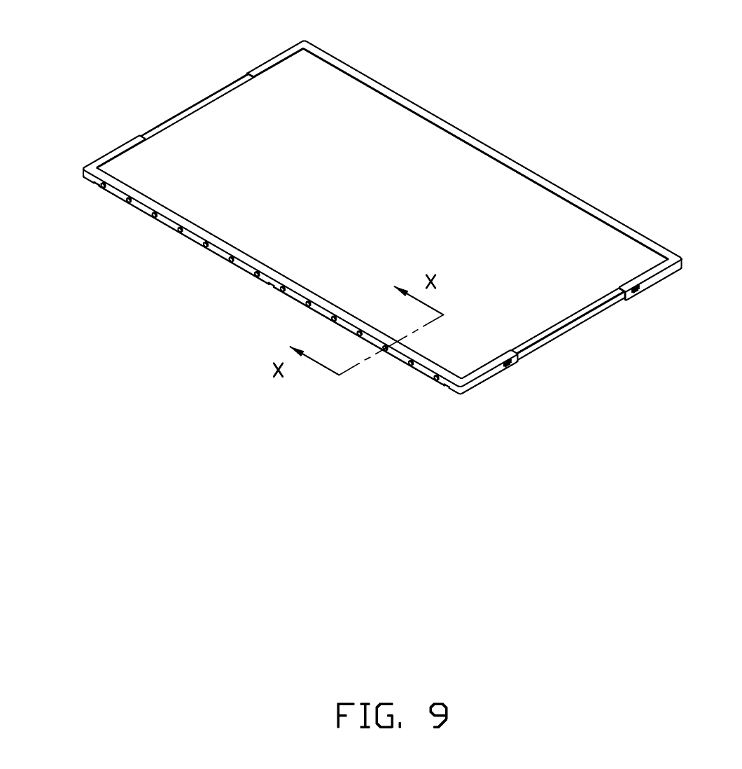

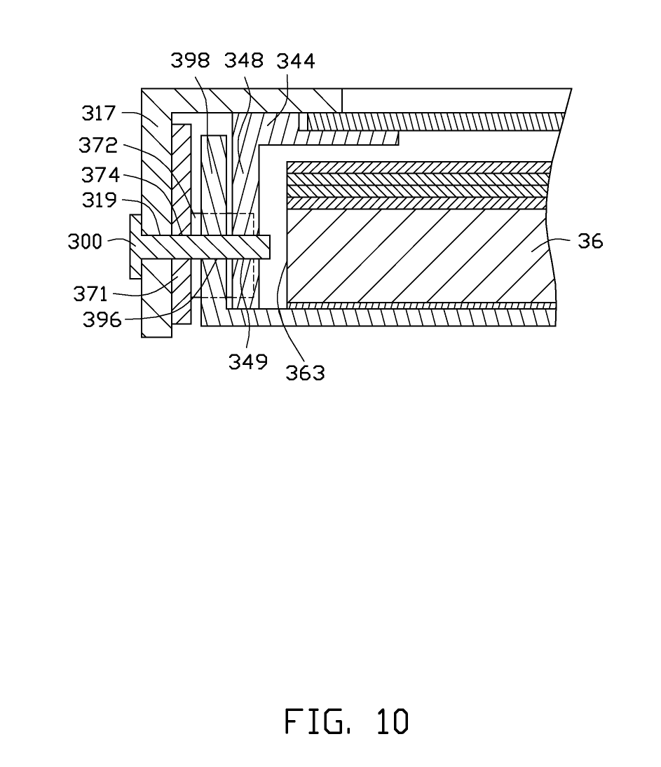

Referring to FIGS. 6-8, a liquid crystal display 3 according to a second embodiment of the present disclosure is shown. The structure of the liquid crystal display 3 is similar to the liquid crystal display 2 except that a number of first fixing pieces 398 are attached on the edge of the bottom plate 391 which corresponds to the opening 395 of the second frame 39, and a number of second fixing pieces 348 are attached on the bottom surface of the second sidewall 344 of the third frame 34 which defines the access 346. Each first fixing piece 398 is located between each two neighboring LEDs 372 which are adjacent to the first fixing piece 395. Each second fixing piece 348 is located between each two neighboring LEDs 372 which are adjacent to the second fixing piece 348. Each first fixing piece 398 defines a first through hole 396. Each second fixing piece 348 defines a second through hole 349, and the second through holes 349 correspond to the first through holes 396. The circuit board 371 of the light source assembly 37 defines a plurality of third through holes 374 corresponding to the first and second through holes 396, 349. The vertical wall 317 of the second portion 314 of the first part 311 defines a plurality of fourth through holes 319. When the liquid crystal display 3 is assembled, referring to FIGS. 9-10, a fixing screw 300 is inserted through the fourth through hole 319, the third through hole 374, the first through hole 396, and the second through hole 349 to attach the circuit board 372 to the vertical wall 317 of the second portion 314 of the first part 311, such that the LEDs 372 are aligned with the light incident surface 363 of the light guide plate 36.

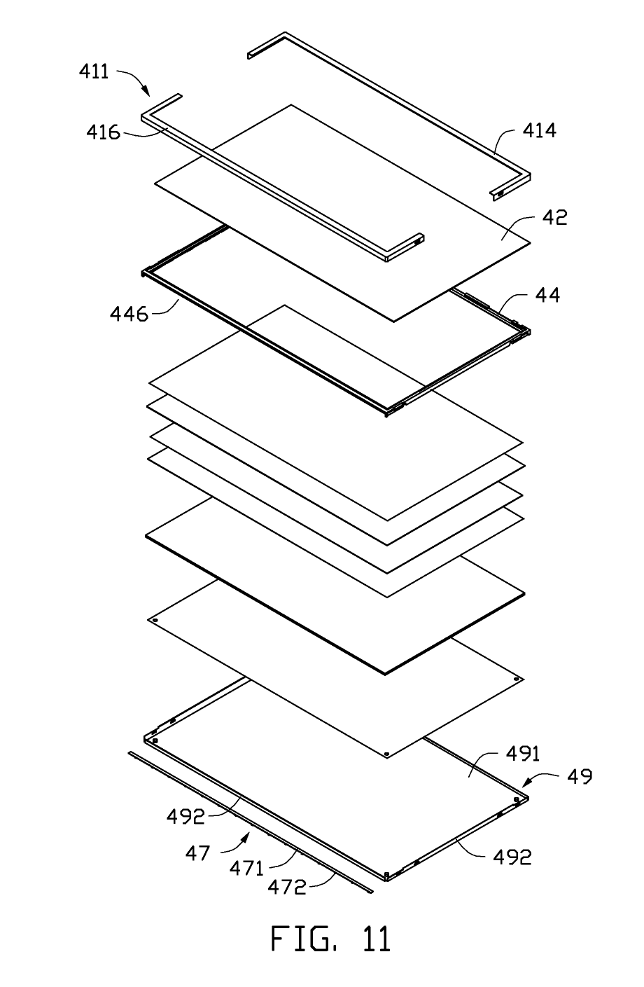

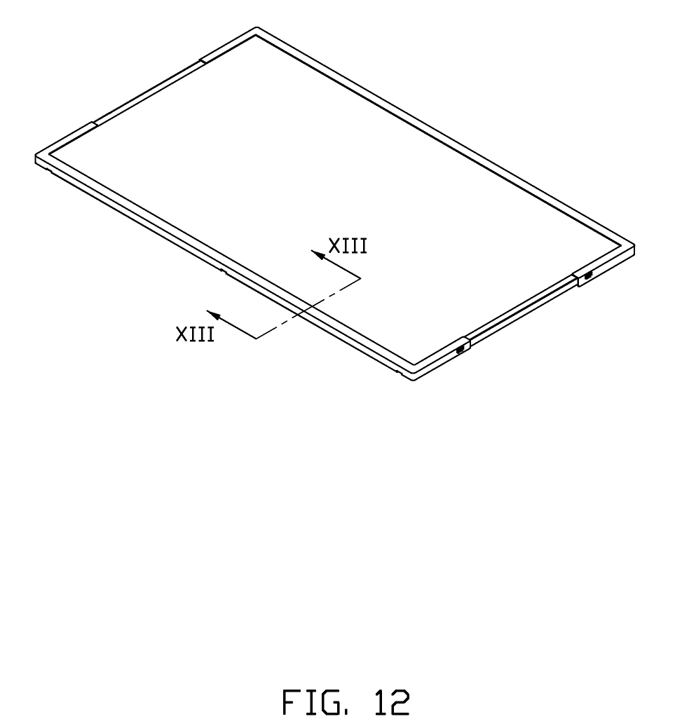

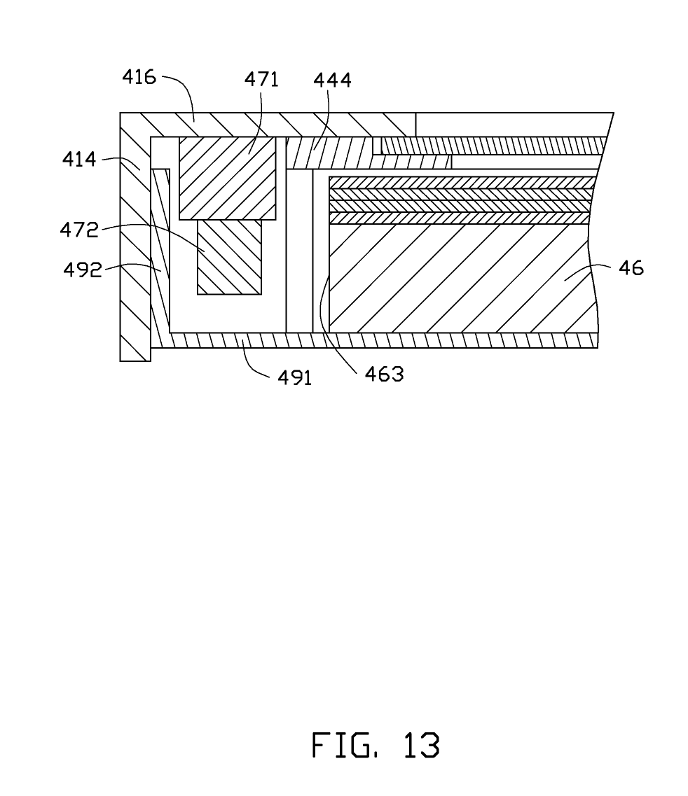

Referring to FIGS. 11-13, a liquid crystal display 4 according to a third embodiment of the present disclosure is shown. The structure of the liquid crystal display 4 is similar to the liquid crystal display 2 except that the second frame 49 includes four first sidewalls 492, the four first sidewalls 492 perpendicularly extending from four edges of the bottom plate 491. One of the four first sidewalls 492 corresponds to the access 446 of the third frame 44. The circuit board 471 of the light source assembly 47 is attached on the horizontal wall 416 of the second portion 414 of the first part 411, with the light source assembly 47 positioned between second sidewall 444 of the third frame 44 and the first sidewall 492 of the second frame 49, and the LEDs 472 are again aligned with the light incident surface 463 of the light guide plate 46.

It is believed that the present embodiments and their advantages will be understood from the foregoing description, and it will be apparent that various changes may be made thereto without departing from the spirit and scope of the description or sacrificing all of their material advantages, the examples hereinbefore described merely being exemplary embodiments.

What is claimed is:

1. A liquid crystal display comprising:
a first frame;
a second frame;
a liquid crystal panel; and
a backlight module comprising a light guide plate, a light source assembly, and a third frame, the light guide plate comprising a light incident surface, the third frame defining an access corresponding to and close to the light incident surface;
wherein the first and second frames cooperate to receive the liquid crystal panel and the backlight module, the light source assembly is attached to the first frame and located outside of the third frame, the light guide plate is received in the third frame, and the light source assembly faces the light incident surface of the light guide plate via the access.

2. The liquid crystal display of claim 1, wherein the light source assembly comprises a circuit board and a plurality of light emitting diodes (LEDs) attached on the circuit board, and the LEDs emit light beams to the light incident surface of the light guide plate through the access.

3. The liquid crystal display of claim 2, wherein the first frame comprises a first part and a second part, each of the first and second parts comprises a first portion, a second portion, and a third portion, each of the first and third portions perpendicularly extends from a respective end of the second portion, all of the first, second and third portions cooperatively form a U-shaped structure, the first, second, and third portions each have a horizontal wall and a vertical wall perpendicular to the horizontal wall, the horizontal walls of the first, second and third portions are coplanar, and the horizontal walls of the first and second parts cooperatively define a display window corresponding to a display screen of the liquid crystal panel.

4. The liquid crystal display of claim 3, wherein the second frame comprises a bottom plate and three first sidewalls, the bottom plate is rectangular and comprises two parallel short edges and two parallel long edges, the three first sidewalls perpendicularly extend from the two parallel short edges and one of the long edges of the bottom plate, the second frame defines an opening at the other long edge of the bottom plate, and the opening corresponds to and is close to the access of the third frame.

5. The liquid crystal display of claim 4, wherein the circuit board of the light source assembly is attached to the vertical wall of the second portion of the first part, and the LEDs are corresponding to and close to the opening and the access.

6. The liquid crystal display of claim 5, wherein the third frame comprises four second sidewalls connected end to end and a horizontal supporting wall inwardly extending from the four second sidewalls, the horizontal supporting wall defines a window therein, the window corresponds to the display window of the first frame, and the liquid crystal panel is supported by the horizontal supporting wall of the third frame, three of the second sidewalls of the third frame are of equal thickness, a thickness of the other second sidewall is less than the thickness of the three second sidewalls, and top surfaces of the four second sidewalls are coplanar, such that there is a distance between a bottom surface of the other second sidewall and a surface where bottom surfaces of the three second sidewalls are located, thereby forming the access at the other second sidewall.

7. The liquid crystal display of claim 6, wherein the second frame comprises a plurality of first fixing pieces attached on the edge of the bottom plate which is corresponding to and close to the opening of the second frame, the third frame comprises a plurality of second fixing pieces attached on the bottom surface of the second sidewall which defines the access, each first fixing piece is located between each two neighboring LEDs which are adjacent to the first fixing pieces, each second fixing piece is located between each two neighboring LEDs which are adjacent to the second fixing pieces, the circuit board attaches on the vertical wall of the second portion of the first part via a fixing screw passing through the vertical wall of the second portion of the first part, the circuit board, a respective one of the first fixing pieces, and a respective one of the second fixing pieces.

8. The liquid crystal display of claim 3, wherein the second frame comprises a bottom plate and four first sidewalls, the bottom plate is rectangular and comprises four side edges, the four first sidewalls perpendicularly extend from the four side edges of the bottom plate, the third frame comprises four second sidewalls connected end to end and a horizontal supporting wall inwardly extending from the four second sidewalls, three of the second sidewalls of the third frame are of equal thickness, a thickness of the other second sidewall is less than the thickness of the three second sidewalls, and top surfaces of the four second sidewalls are coplanar, such that there is a distance between a bottom surface of the other second sidewall and a surface where bottom surfaces of the three second sidewalls are located, thereby forming the access at the other second sidewall.

9. The liquid crystal display of claim 8, wherein the light source assembly is attached to the horizontal wall of the second portion of the first part, and the light source assembly is positioned between one of the first sidewalls of the second frame and the third frame, with the LEDs facing the light incident surface of the light guide plate through the access.

10. The liquid crystal display of claim 1, wherein the second frame comprises four fixing poles extending from a bottom plate of the second frame and located close to four corners of the bottom plate, the light guide plate defines four fixing holes therein, the fixing holes spatially correspond to the fixing poles of the second frame, the backlight module further comprises a reflector adjacent to a bottom surface of the light guide plate, and the reflector defines four through holes at its four corners, and the four through holes are spatially corresponding to the fixing poles of the second frame.

11. A liquid crystal display comprising:
a first frame;
a second frame;
a liquid crystal panel; and
a backlight module comprising a light guide plate, a light source assembly, and a third frame, the light guide plate comprising a light incident surface, the third frame defining an access corresponding to and close to the light incident surface;
wherein the first and second frames cooperate to receive the liquid crystal panel and the backlight module, the light source assembly is fixed on an inner surface of the first frame and located outside of the third frame, the light guide plate is received in the third frame, the light source assembly is corresponding to and close to the light incident surface of the light guide plate, light beams emitted from the light source assembly reach the light incident surface through the access of the third frame.

12. The liquid crystal display of claim 11, wherein the light source assembly comprises a circuit board and a plurality of light emitting diodes (LEDs) attached on the circuit board, and the LEDs face the light incident surface of the light guide plate.

13. The liquid crystal display of claim 12, wherein the first frame comprises a first part and a second part, each of the first and second parts comprises a first portion, a second portion, and a third portion, each of the first and third portions perpendicularly extends from a respective end of the second portion, all of the first, second and third portions cooperatively form a U-shaped structure, the first, second, and third portions each have a horizontal wall and a vertical wall perpendicular to the horizontal wall, the horizontal walls of the first, second and third portions are coplanar, and the horizontal walls of the first and second parts cooperatively define a display window corresponding to a display screen of the liquid crystal panel.

14. The liquid crystal display of claim 13, wherein the second frame comprises a bottom plate and three first sidewalls, the bottom plate is rectangular and comprises two parallel long edges and two parallel short edges, the three first sidewalls perpendicularly extend from the two parallel short edges and one of the long edges of the bottom plate, the second frame defines an opening at the other long edge of the bottom plate, and the opening spatially corresponds to the access of the third frame.

15. The liquid crystal display of claim 14, wherein the circuit board of the light source assembly is attached to the vertical wall of the second portion of the first part, and the LEDs are corresponding to and close to the opening and the access.

16. The liquid crystal display of claim 15, wherein the third frame comprises four second sidewalls connected end to end and a horizontal supporting wall inwardly extending from the four second sidewalls, the horizontal supporting wall defines a window therein, the window corresponds to the display window of the first frame, and the liquid crystal panel is supported by the horizontal supporting wall of the third frame, three of the second sidewalls of the third frame are of equal thickness, a thickness of the other second sidewall is less than the thickness of the three second sidewalls, and top surfaces of the four second sidewalls are coplanar, such that there is a distance between a bottom surface of the other second sidewall and a surface where bottom surfaces of the three second sidewalls are located, thereby defining the access at the other second sidewall.

17. The liquid crystal display of claim 16, wherein the second frame comprises a plurality of first fixing pieces attached on the edge of the bottom plate which is corresponding to the opening of the second frame, the third frame comprises a plurality of second fixing pieces attached on the bottom surface of the second sidewall of the third frame which defines the access, each first fixing piece is located between each two neighboring LEDs which are adjacent to the first fixing pieces, each second fixing piece is located between each two neighboring LEDs which are adjacent to the second fixing pieces, the circuit board attaches on the vertical wall of the second portion of the first part via a fixing screw passing through the vertical wall of the second portion of the first part, the circuit board, a respective one of the first fixing pieces, and a respective one of the second fixing pieces.

18. The liquid crystal display of claim 13, wherein the second frame comprises a bottom plate and four first sidewalls, the bottom plate is rectangular and comprises four side edges, and the four first sidewalls perpendicularly extend from the four side edges of the bottom plate, the third frame comprises four second sidewalls connected end to end and a horizontal supporting wall inwardly extending from the four second sidewalls, three of the second sidewalls of the third frame are of equal thickness, a thickness of the other second sidewall is less than the thickness of the three second sidewalls, and top surfaces of the four second sidewalls are coplanar, such that there is a distance between a bottom surface of the other second sidewall and a surface where bottom surfaces of the three second sidewalls are located, thereby defining the access at the other second sidewall.

19. The liquid crystal display of claim 18, wherein the light source assembly is attached to the horizontal wall of the second portion of the first part, and the light source assembly is positioned between one of the first sidewalls of the second frame and the third frame, with the LEDs facing the light incident surface of the light guide plate through the access.

20. The liquid crystal display of claim 11, wherein the second frame comprises four fixing poles extending from a bottom plate of the second frame and located close to four corners of the bottom plate, the light guide plate defines four fixing holes therein, the fixing holes spatially correspond to the fixing poles of the second frame, the backlight module further comprises a reflector adjacent to a bottom surface of the light guide plate, the reflector defines four through holes at its four corners, and the four through holes are spatially corresponding to the fixing poles of the second frame.
